(19) United States
(12) Patent Application Publication
(10) Pub. No.: US 2014/0119057 A1
(43) Pub. Date: May 1, 2014

(54) SYNTHETIC RESIN SOCKET

(71) Applicants: LEDLINK OPTICS(DONG GUAN)CO., LTD., Dongguan City (CN); LEDLINK OPTICS, INC., New Taipei City (TW); LEDLINK OPTICS(YANG ZHOU)CO.,LTD, Yangzhou City (CN)

(72) Inventor: Tetsuya TOSHIKAWA, Osaka (JP)

(73) Assignees: LEDLINK OPTICS(DONG GUAN)CO., LTD., Dongguan City (CN); LEDLINK OPTICS, INC., New Taipei City (TW); LEDLINK OPTICS(YANG ZHOU)CO.,LTD, Yangzhou City (CN)

(21) Appl. No.: 14/059,053

(22) Filed: Oct. 21, 2013

(30) Foreign Application Priority Data
Oct. 26, 2012 (JP) 2012-236976
Jan. 16, 2013 (JP) 2013-5637

(51) Int. Cl. F21V 19/00

(52) U.S. Cl. CPC F21V 19/001
USPC 362/655

(57) ABSTRACT

Disclosed is a synthetic resin socket, which the LED module won't fall and can be securely held during the assembly operation to promote the efficiency of the assembly operation. The holder comprises an arm and a holding part formed at a front end of the arm. A holder accommodating room is formed at a bottom side of the socket main body. The holder protrudes from the inside of the holder accommodating room toward the lower surface of the socket main body for holding and temporarily setting the LED module. The arm of the holder is possible to be laterally elastically deformed, and as installation to an object to be installed, the objective presses against the holder and the arm provides resin elasticity to secure the hold status of the LED module, and the holder is elastically deformed toward the inside of the holder accommodating room to receive the LED module.

### BACKGROUND OF THE INVENTION

1. Field of the Invention

The present invention generally relates to a synthetic resin socket for installing a LED module in lighting equipment employing the LED (Light Emitting Diode) as a light source.

2. Description of Prior Art

Traditionally, in the lighting equipment employing a LED, the constitution of a heat sink, and a synthetic resin socket for installing the LED module on the heat sink is well known. Here, the synthetic resin socket means a socket mostly formed by synthetic resin except terminals.

The synthetic resin socket utilized in the LED lighting equipment can be a fixing constitution of the LED, for example, comprising the LED for providing a power unit at two ends of one side on the surface of the LED, a heat sink for fixing the LED and an isolated socket (holder) having an opening for fitting the appearance of the LED with certain thickness. At the two ends of the one side of the socket, extending plate-like metal wires are inserted along the direction orthogonal to the power unit direction. In the opening, the metal wires at least protrude their side ends inside the opening and the other ends of the metal wires employed as connection terminals protrude to the outside of the socket. The LED set from the heat sink is located inside the opening of the socket. The socket is fixed at the surface of the heat sink by fixing means. The power unit of the LED is pressed toward the heat sink by the metal wires inside the opening. Such fixing constitution of the LED and the socket for realizing thereof are well known (For example, the cited patent 1).

Furthermore, a socket assembly comprising a lighting package, a socket housing having a receptacle capable of removing the lighting package and a heat management structure jointing with the socket housing, wherein the heat management structure contacting the heat sink for conducting heat from the lighting package to the heat sink is disclosed. Such constitution is also well known (For example, the cited patent 2).

The cited patent 1: Japan Patent. No. 4582087

The cited patent 2: Japan Patent Publication No. 2001-142312

### SUMMARY OF THE INVENTION

In the invention of the cited patent 1, as installing the synthetic resin socket and LED to the heat sink, the fixing hole of the synthetic resin socket and the tapped hole of the heat sink are aligned and screwed after the LED module is inserted from the inner side and set inside the opening of the synthetic resin socket.

However, with such constitution, there is a chance that the LED module might fall from the socket, in the status that the LED module is inserted inside the opening of the synthetic resin socket and in the procedure that the fixing hole of the synthetic resin socket and the tapped hole of the heat sink are aligned. The LED module's fall may lead to the damage to the LED module itself and the malfunction. Meanwhile, for preventing the LED module falling, the assembly operation requires careful behaviors and therefore, the speed of the assembly operation is inhibited and the assembly operation can be dragged down thereby.

On the other hand, the structure disclosed by the invention of the cited patent 2 is provided for easy removal and exchange. According to the structure, it will be easier for fixation when the LED module is mounted to the socket. However, with the foregoing structure, the LED module is mounted from the top side of the socket. There is risk that the bad insertion of the LED module to the socket occurs and the detachment of the LED module due to the deformation or contact of the fittings.

With the viewpoints of the present invention, an objective of the present invention is to provide an excellent synthetic resin socket, which the LED module won't fall and the efficiency of the assembly operation can be promoted.

For solving the aforesaid issues, the present invention provides a synthetic resin socket, having a holder in a socket main body made of synthetic resin for holding the LED module, the holder comprises an arm and a holding part formed at a front end of the arm; at least one holder accommodating room is formed at a bottom side of the socket main body; the holder protrudes from the inside of the holder accommodating room toward the lower surface of the socket main body for holding and temporarily setting the LED module; and the arm of the holder is possible to be laterally elastically deformed, and as installation to an object to be installed, with the object to be installed presses against the holder and the arm provides resin elasticity to secure the hold status of the LED module, and the holder is elastically deformed toward the inside of the holder accommodating room to be accommodated.

Moreover, for solving the aforesaid issues, the present invention provides a synthetic resin socket, having a holder in a socket main body made of synthetic resin for holding the LED module, the holder comprises an arm and a holding part formed at a front end of the arm; at least one holder accommodating room is formed at a bottom side of the socket main body; at least a pair of the holder protrudes from the inside of the holder accommodating room toward the lower surface of the socket main body for holding and temporarily setting the LED module; and the arm of the holder is possible to be laterally elastically deformed, and as installation to an object to be installed, the object to be installed presses against the holder and the arm provides resin elasticity to secure the hold status of the LED module, and the holder is elastically deformed toward the inside of the holder accommodating room to be accommodated.

As based on any configurations of the invention, the present invention is further configured in that the arm of the holder is rectangular in cross section for solving the aforesaid issues.

As based on any configurations of the invention, the present invention is further configured in that a guide recess in accordance with an appearance of the LED module is formed at the bottom side of the socket main body for solving the aforesaid issues.

Furthermore, the present invention is configured in that the guide recess and the holder are employed to hold the LED module for solving the aforesaid issues.

As based on any configurations of the invention, the present invention is further configured in that a pair of the arm is point symmetrically positioned which a rough center position of a receiving space holding the LED module is a reference point for solving the aforesaid issues.

According to the present invention, the synthetic resin socket, having a holder in a socket main body made of synthetic resin for holding the LED module is constituted that the holder comprises an arm and a holding part formed at a front end of the arm; at least one holder accommodating room is formed at a bottom side of the socket main body; the holder protrudes from the inside of the holder accommodating room toward the lower surface of the socket main body for holding and temporarily setting the LED module; and the arm of the holder is possible to be laterally elastically deformed, and as installation to an object to be installed, the object to be installed presses against the holder and the arm provides resin elasticity to secure the hold status of the LED module, and the holder is elastically deformed toward the inside of the holder accommodating room to be accommodated. Accordingly, the loading of the installation work can be reduced from start to finish of the installation procedures. The LED module can be held securely and the damage and pollution of the LED module due to the falling can be prevented.

As installing the LED module, the holding parts protruding downward from the bottom side can hold the lateral sides of the LED module. Then, the position of the LED module toward the guide recess can be easily determined and the assembly operation of the LED module can be promoted.

As installation to an object to be installed, the object to be installed presses against the holder and the arm provides resin elasticity to secure the hold status of the LED module, and the holder is elastically deformed toward the inside of the holder accommodating room to be accommodated. Then, a hole for installing the object to be installed which avoids the holding part becomes unnecessary and the installation can be easier. Meanwhile, with the aforesaid constitution, the bad installation and the detachment will not happen between the LED module and the object to be installed, such as the synthetic resin socket and the heat sink, and etc. moreover, as mounting the LED module, hard press to the LED module is not necessary. Therefore, the installation can be proceeded with remaining the quality of the LED module.

As aforementioned, according to the present invention, the holder having the holding part and the arm protrudes with the holding part from the bottom in the general status. As installing the LED module, the holder is elastically deformed toward the width direction, and securely holding the LED module. Meanwhile, during the installation to the object to be installed, such as the heat sink and etc., the holder is elastically deformed toward the inside of the holder accommodating room to be accommodated and maintains the status of holding the LED module. Therefore, it functions very best and exhibits the foregoing excellent effect.

As based on the aforesaid configuration of the invention, the arm of the holder is rectangular in cross section. Beside the foregoing effect of the present invention, the deformation at other directions can be prevented to stable the movement of the holder because the accommodating direction for the holder and the holder is only allowed to be easily deformed at the width direction by utilizing the resin elasticity as installing the LED module.

As based on any aforesaid configurations of the invention, a guide recess in accordance with an appearance of the LED module is formed at the bottom side of the socket main body. Beside any foregoing effect of the present invention, as the LED module is in the status to be guided with the guide recess at the bottom side of the socket main body, the chips can be kept more stably because the holder holds the socket.

In the synthetic resin socket forming the guide recess according to the present invention, the guide recess and the holder are configured to hold the LED module. Then, the deformation of the guide recess holding the LED module does not happen and the position of the LED module can be easily determined. Therefore, the assembly operation of the LED module can be simplified.

As based on any aforesaid configurations of the invention, a pair of the arm is point symmetrically positioned which a rough center position of a receiving space holding the LED module is a reference point. Beside any foregoing effect of the present invention, the reaction due to the elastic deformation of the holder which can hold the LED module from the two lateral sides toward the rough center of the LED module with great balance can be provided. Accordingly, the pressure to the LED module can be reduced.

### BRIEF DESCRIPTION OF THE DRAWINGS

FIG. 1(a) depicts a perspective drawing showing the top, the front side and the left side of the synthetic resin socket according to the first embodiment of the present invention.

FIG. 1(b) depicts a perspective drawing showing the bottom, the back side and the right side of the synthetic resin socket according to the first embodiment of the present invention.

FIG. 2(a) depicts a top view of the synthetic resin socket according to the first embodiment of the present invention.

FIG. 2(b) depicts a bottom view of the synthetic resin socket according to the first embodiment of the present invention.

FIG. 3(a) depicts an A-A sectional view of the synthetic resin socket shown in FIG. 2(a) according to the first embodiment of the present invention.

FIG. 3(b) depicts a B-B sectional view of the synthetic resin socket shown in FIG. 2(a) according to the first embodiment of the present invention.

FIG. 3(c) depicts a C-C sectional view of the synthetic resin socket shown in FIG. 2(b) according to the first embodiment of the present invention.

FIG. 4 depicts a perspective drawing showing the installation status of the socket substrate and the socket frame plate of the synthetic resin socket according to the first embodiment of the present invention.

FIG. 5(a) depicts a top side perspective drawing of the synthetic resin socket installed with the LED module according to the first embodiment of the present invention.

FIG. 5(b) depicts a back side perspective drawing of the synthetic resin socket installed with the LED module according to the first embodiment of the present invention.

FIG. 6 depicts a bottom side perspective drawing of the synthetic resin socket and an enlarged drawing around the holder according to the first embodiment of the present invention.

FIG. 7(a) depicts a perspective drawing showing the top, the back side and the left side of the synthetic resin socket installed with the LED module according to the first embodiment of the present invention.

FIG. 7(b) depicts a perspective drawing showing the bottom, the front side and the right side of the synthetic resin socket installed with the LED module according to the first embodiment of the present invention.

FIG. 8 depicts a perspective drawing of the LED-installed synthetic resin socket installed with the heat sink according to the first embodiment of the present invention.

FIG. 9(a) depicts a A-A longitudinal sectional view of the status that the synthetic resin socket is installed with the LED module shown in FIG. 2(a) according to the first embodiment of the present invention.

FIG. 9(b) depicts a C-C longitudinal sectional view of the status before the synthetic resin socket is installed with the heat sink shown in FIG. 2(b) according to the first embodiment of the present invention.

FIG. 9(c) depicts a C-C longitudinal sectional view of the status after the synthetic resin socket is installed with the heat sink shown in FIG. 2(b) according to the first embodiment of the present invention.

FIG. 10(a) depicts a perspective drawing showing the top, the front side and the left side of the synthetic resin socket according to the second embodiment of the present invention.

FIG. 10(b) depicts a perspective drawing showing the bottom, the back side and the right side of the synthetic resin socket according to the second embodiment of the present invention.

FIG. 11(a) depicts a top view of the synthetic resin socket according to the second embodiment of the present invention.

FIG. 11(b) depicts a bottom view of the synthetic resin socket according to the second embodiment of the present invention.

FIG. 12(a) depicts a D-D sectional view of the synthetic resin socket according to the second embodiment of the present invention.

FIG. 12(b) depicts an E-E sectional view of the synthetic resin socket according to the second embodiment of the present invention.

FIG. 12(c) depicts an F-F sectional view of the synthetic resin socket according to the second embodiment of the present invention.

FIG. 13 depicts a perspective drawing showing the installation status of the socket substrate and the socket frame plate of the synthetic resin socket according to the second embodiment of the present invention.

FIG. 14(a) depicts a top side perspective drawing of the synthetic resin socket installed with the LED module according to the second embodiment of the present invention.

FIG. 14(b) depicts a back side perspective drawing of the synthetic resin socket installed with the LED module according to the second embodiment of the present invention.

FIG. 15 depicts a bottom side perspective drawing of the synthetic resin socket and an enlarged drawing around the holder according to the second embodiment of the present invention.

FIG. 16(a) depicts a perspective drawing showing the top, the back side and the left side of the synthetic resin socket installed with the LED module according to the second embodiment of the present invention.

FIG. 16(b) depicts a perspective drawing showing the bottom, the front side and the right side of the synthetic resin socket installed with the LED module according to the second embodiment of the present invention.

FIG. 17 depicts a perspective drawing of the LED-installed synthetic resin socket installed with the heat sink according to the second embodiment of the present invention.

FIG. 18(a) depicts a longitudinal sectional view of the status before the synthetic resin socket is installed with the heat sink according to the second embodiment of the present invention.

FIG. 18(b) depicts a longitudinal sectional view of the status after the synthetic resin socket is installed with the heat sink according to the second embodiment of the present invention.

FIG. 19(a) depicts a perspective drawing showing the top, the front side and the left side of the synthetic resin socket according to the third embodiment of the present invention.

FIG. 19(b) depicts a perspective drawing showing the bottom, the back side and the right side of the synthetic resin socket according to the third embodiment of the present invention.

FIG. 20(a) depicts a top view of the synthetic resin socket according to the third embodiment of the present invention.

FIG. 20(b) depicts a bottom view of the synthetic resin socket according to the third embodiment of the present invention.

FIG. 21(a) depicts a G-G sectional view of the synthetic resin socket according to the third embodiment of the present invention.

FIG. 21(b) depicts an H-H sectional view of the synthetic resin socket according to the third embodiment of the present invention.

FIG. 21(c) depicts a J-J sectional view of the synthetic resin socket according to the third embodiment of the present invention.

FIG. 22 depicts a perspective drawing showing the installation status of the socket substrate and the socket frame plate of the synthetic resin socket according to the third embodiment of the present invention.

FIG. 23(a) depicts a top side perspective drawing of the synthetic resin socket installed with the LED module according to the third embodiment of the present invention.

FIG. 23(b) depicts a back side perspective drawing of the synthetic resin socket installed with the LED module according to the third embodiment of the present invention.

FIG. 24 depicts a bottom side perspective drawing of the synthetic resin socket and an enlarged drawing around the holder according to the third embodiment of the present invention.

FIG. 25(a) depicts a perspective drawing showing the top, the back side and the left side of the synthetic resin socket installed with the LED module according to the third embodiment of the present invention.

FIG. 25(b) depicts a perspective drawing showing the bottom, the front side and the right side of the synthetic resin socket installed with the LED module according to the third embodiment of the present invention.

FIG. 26 depicts a perspective drawing of the LED-installed synthetic resin socket installed with the heat sink according to the third embodiment of the present invention.

FIG. 27(a) depicts a longitudinal sectional view of the status before the LED-installed synthetic resin socket is installed with the heat sink according to the third embodiment of the present invention.

FIG. 27(b) depicts a longitudinal sectional view of the status after the LED-installed synthetic resin socket is installed with the heat sink according to the third embodiment of the present invention.

### DETAILED DESCRIPTION OF THE INVENTION

In the synthetic resin socket, having a holder in a socket main body made of synthetic resin for holding the LED module, the holder comprises an arm and a holding part formed at a front end of the arm; at least one holder accommodating room is formed at a bottom side of the socket main body; the holder protrudes from the inside of the holder accommodating room toward the lower surface of the socket main body for holding and temporarily setting the LED module; and the arm of the holder is possible to be laterally elastically deformed, and as installation to an object to be installed, the object to be installed presses against the holder and the arm provides resin elasticity to secure the hold status of the LED module, and the holder is elastically deformed toward the inside of the holder accommodating room to be accommodated. The loading of the installation work can be reduced. The LED module can be hold securely from start to finish of the installation procedures and the damage and pollution of the LED module due to the falling can be prevented. Meanwhile, as installing the LED module, the holding parts protruding downward from the bottom side can hold the lateral sides of the LED module. Then, the position of the LED module toward the guide recess can be easily determined and the assembly operation of the LED module can be promoted. An arm of the holder is rectangular in cross section. The deformation at other directions can be prevented to stable the movement of the holder because the holder is only allowed to be easily deformed at the desired direction by utilizing the resin elasticity. A guide recess in accordance with an appearance of the LED module is formed at the bottom side of the socket main body. As the LED module is in the status to be guided with the guide recess at the bottom side of the socket main body, the chips can be kept more stably because the holder holds the socket. A pair of the holding arm is point symmetrically positioned which a rough center position of a receiving space holding the LED module is a reference point. The reaction due to the elastic deformation of the holder which can hold the LED module from the two lateral sides toward the rough center of the LED module with great balance can be provided. Then, the loading to the LED module can be reduced. Accordingly, an excellent synthetic resin socket can be realized.

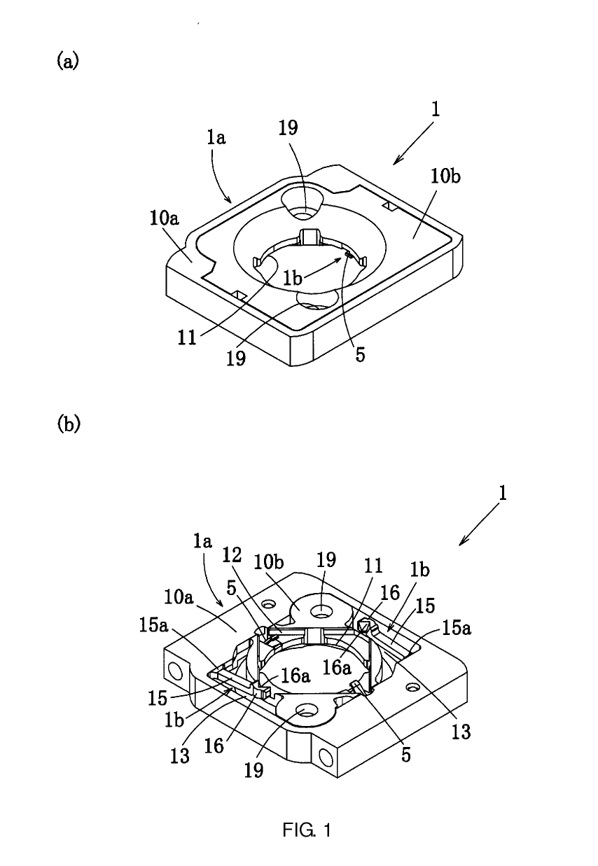

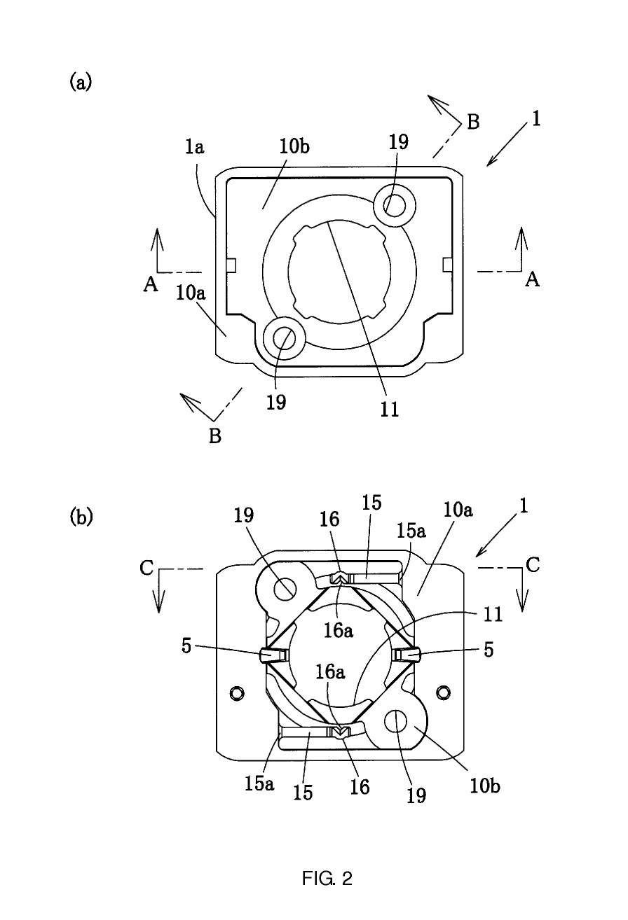

As shown from FIG. 1 to FIG. 9, the synthetic resin socket 1 of the first embodiment according to the present invention is constituted by a socket frame plate 10a made of synthetic resin and a socket substrate 10b made of synthetic resin. The socket main body 1a, which respectively accommodates terminal metal parts 5, 5 at the positive and negative sides, comprises a guide recess 12 for determining the position of the LED module 2 and a holder 1b for holding the LED module 2.

A light opening 11 is formed at the center of the synthetic resin socket 1. The guide recess 12 for determining the position of the LED module 2 and a holder 1b for holding the LED module 2 hold the bottom side of the LED module 2. The LED power unit 21 of the LED module 2 and the terminal metal parts 5, 5 are in contact status and the LED light source 20 of the LED module 2 projects light through the light opening 11 of the synthetic resin socket 1. Meanwhile, the LED module 2 utilized in first the embodiment is a well known product. Details of respective components are introduced hereafter.

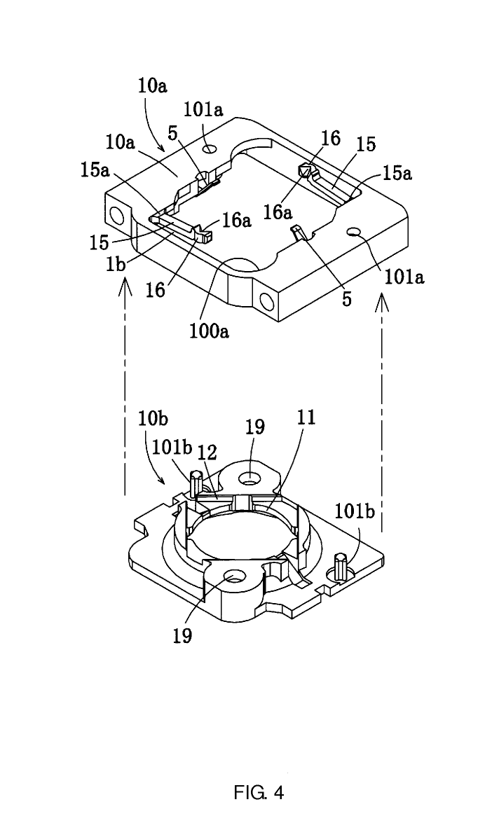

In the first embodiment, the socket frame plate 10a and the holder 1b are formed in one piece. As shown in FIG. 4, the socket frame plate 10a is embedded with the socket substrate 10b under the status when the terminal metal part 5 is inserted inside the socket frame plate 10a. Then, the synthetic resin socket 1 is constituted.

The socket frame plate 10a comprises terminal fittings 14 for installing the terminal metal parts 5, 5. The terminal metal parts 5, 5 comprise contact parts 50 and terminal bases 51. As the terminal bases 51 are embedded into the terminal fittings 14, the contacts 50 are placed to protrude with contacting the power unit 21 of the LED module 2.

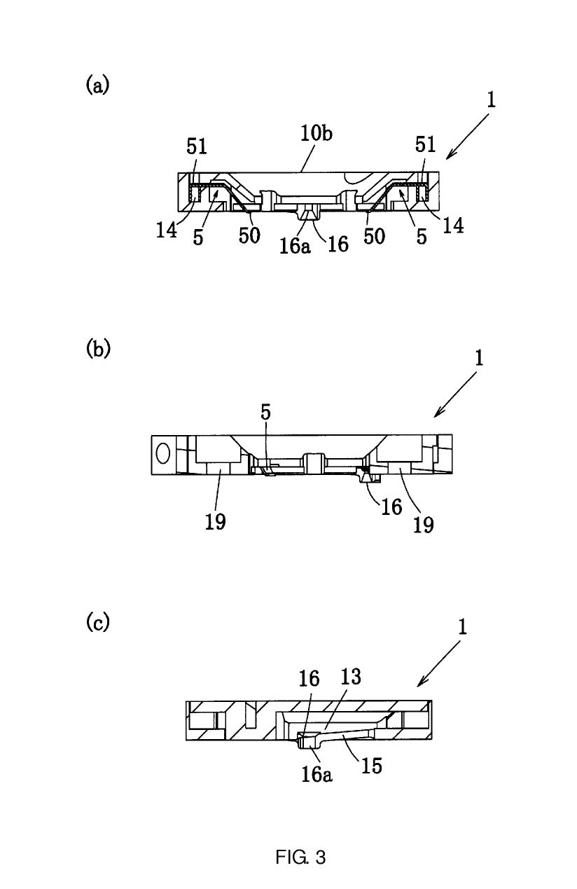

Moreover, the socket frame plate 10a is a frame-like object which a frame side opening 100a is formed at the center. The holder 1b extends in one piece from the socket frame plate 10a. The holder 1b extends in width direction (a little downwards) and from the end of the front and the back of the lateral sides of the socket frame plate 10a. The holder 1b comprises an arm 15 and a holding part 16 formed at the front end of the arm 15. As shown in FIG. 3(c), the sectional view, the holding part 16 of the holder 1b is in a status of protruding downwards from the bottom side.

The thickness of the holding part 16 formed at the front end of the arm 15 is slightly larger than that of the arm 15. In this first embodiment, for fitting the appearance of the rectangular plate-like LED module 2, cutouts 16a are formed. The cutouts 16a closely contact the corners 22 and are roughly 90 degrees V shaped or U shaped from the top view. The cutouts 16a do not require to be formed with extremely high accuracy. For example, both the most inner part and the whole of the cutouts 16a can be formed roughly. The LED module 2 can be caught by the cutouts 16a and therefore, the holding status thereof can be more stable.

The arm 15 is formed as being rectangular in cross section. The arm 15 can be deformed both in the up/down direction and right/left direction of the rectangle (i.e. the accommodating direction of the holding 1b and the width direction as installing the LED module 2 in the synthetic resin socket 1) with the resin elasticity.

Because of the rectangle in cross section, the deformation in the slanted direction with the resin elasticity hardly occurs. With such constitution, the holder 1b can affirmably function necessarily and prevent the undesired deformation to allow the holder 1b to be actuated more stably.

A lighting part is formed on the top side of the socket substrate 10b according to the first embodiment of the present invention. The socket substrate 10b comprises a light opening 11 at the center. Mounting holes 19 penetrating the socket substrate 10b vertically are formed at two locations of the edges. The mounting holes 19 are employed for installing the synthetic resin socket 1 to the heat sink 3.

Meanwhile, the guide recess 12 for determining the position of the LED module 2 is formed at the edges of the light opening 11 at the bottom side of the socket substrate 10b. The holder accommodating rooms 13 for accommodating the holders 1b correspondingly are formed in the front and the back of the guide recess 12. Moreover, fitting protrusions 101b for embedding the socket frame plate 10a are also formed at the bottom side of the socket substrate 10b.

In the synthetic resin socket 1 of the first embodiment according to the present invention, the fitting recesses 101a of the socket frame plate 10a and the fitting protrusions 101b of the socket substrate 10b are embedded for achieving one piece as the terminal bases 51 of the terminal metal parts, 5, 5 are embedded into the terminal fittings 14.

In the aforementioned constitution, the guide recess 12 is located under the socket substrate 10b. However, in the status of embedding with the socket frame plate 10a, the LED module 2 can be guided against the guide recess 12 from the bottom side of the socket frame plate 10a because the guide recess 12 is exposed toward the bottom side of the socket frame plate 10a.

With utilizing the foregoing synthetic resin socket 1, the installation procedure of the heat sink 3 employed as the object to be installed with the LED module 2 is introduced herewith. Meanwhile, the tapped holes 30 are formed on the heat sink 3 for fixing the synthetic resin socket 1.

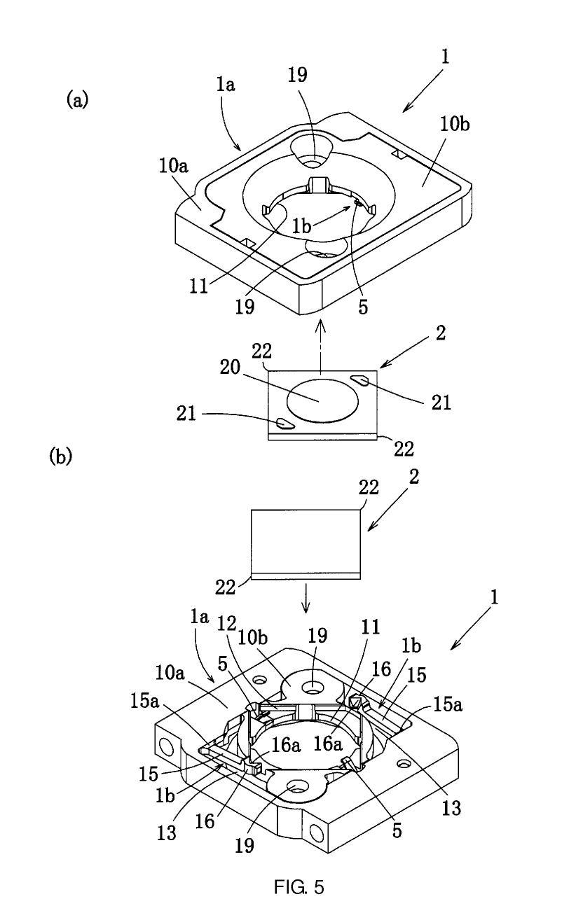

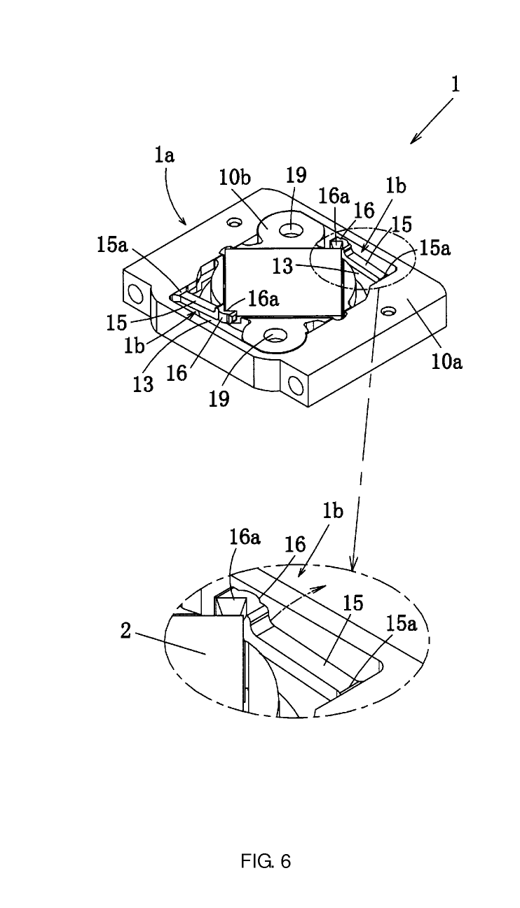

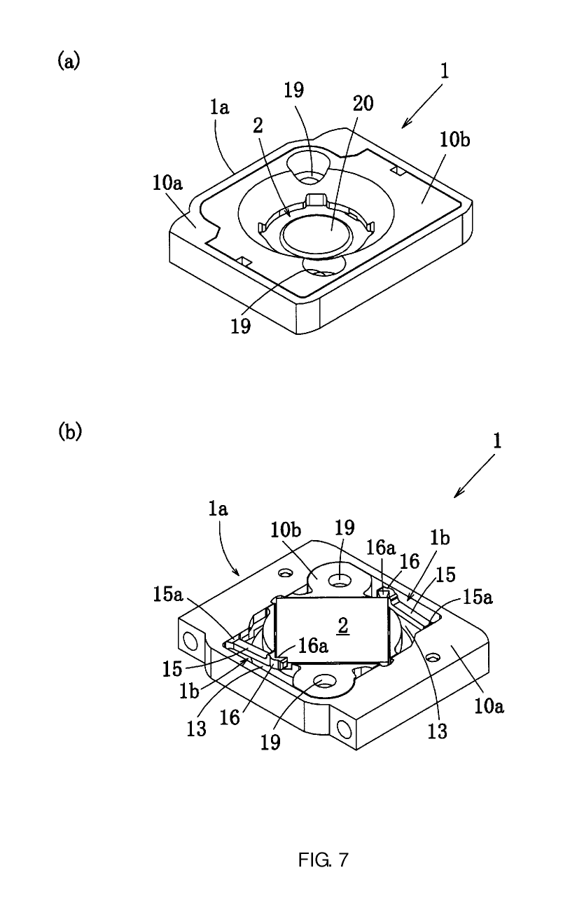

As shown in FIG. 5, as the LED module 2 which is rectangular in top view is guided against the guide recess 12 at the back side of the synthetic resin socket 1, the front ends of the terminal metal part 5, 5 protrude near the guide recess 12 and contact the LED power unit 21 of the LED module 2. Meanwhile, one set of opposite corners 22 of the LED module 2 are held by the holding parts 16 of the holder 1b. On this occasion, as shown by the dotted arrows indicated in FIG. 6, the arms 15 at two locations are slightly deformed outwards. With the reaction, the LED module 2 is temporarily set (as shown in FIG. 7).

Then, the synthetic resin socket 1 temporarily setting the LED module 2 is installed to the heat sink 3. In this installation, although the LED module 2 is mounted at the bottom side of the synthetic resin socket 1 and temporarily set, there will be no concern about falling because the LED module 2 is guided by the guide recess 12.

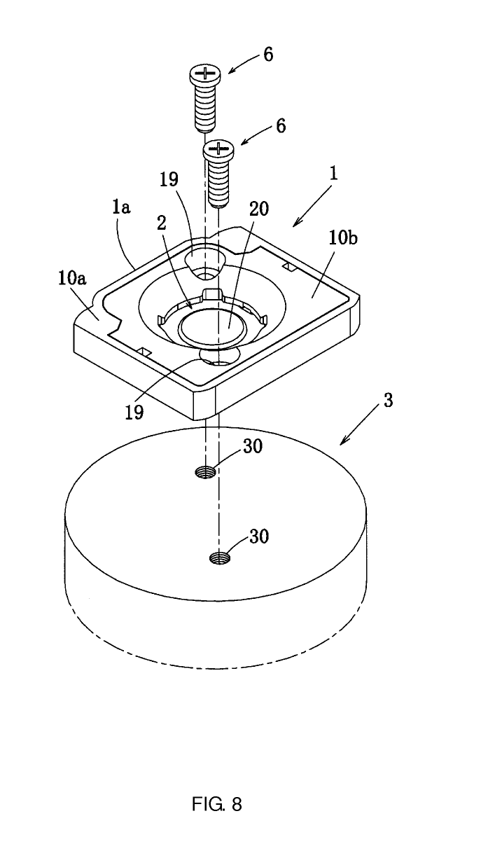

As shown in FIG. 8, the installation of the synthetic resin socket 1 to the heat sink 3 can be realized by utilizing the screwing means, such as fixing screws 6. In the first embodiment, the fixing screws 6 can be screwed into the tapped holes 30 of the heat sink 3 through the mounting holes 19 of the synthetic resin socket 1.

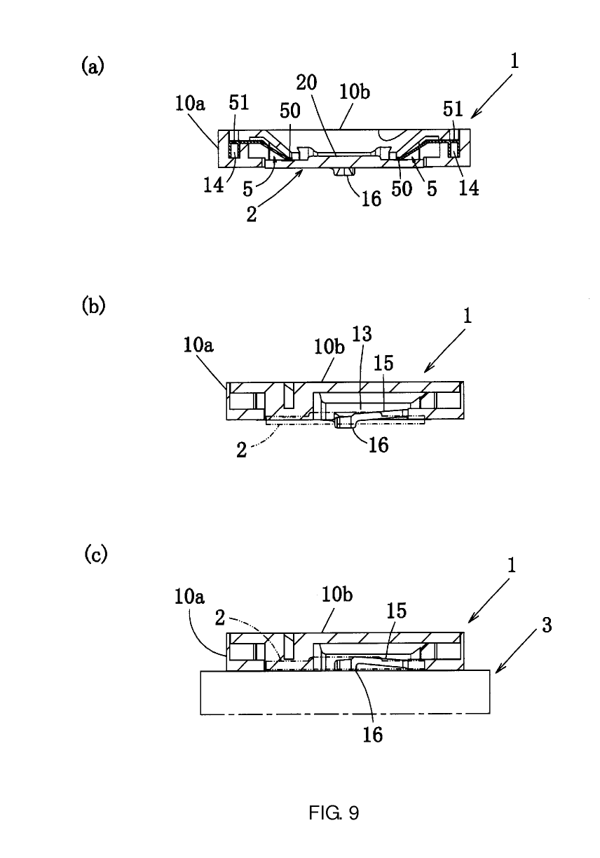

By screwing the screwing means (male screws), such as, screwing with the female screws of the heat sink 3, the holding parts 16 protruding from the bottom side of the synthetic resin socket 1 are slightly moved inwards toward the inside of the holder accommodating room 13. However, because the thickness of the holding parts 16 is slightly larger than that of the LED module 2, the LED module 2 will not deviate from the holding parts 16. Only the holding parts 16 enter the inside of the holder accommodating room 13 and the LED module 2 presses against the guide recess 12 due to the static friction between the LED module 2 and the holding parts 16 (Refer to FIG. 9(b) and (c)). Besides, in the first embodiment, the thickness of the LED module 2 (the thickness of the contact part of the synthetic resin socket 1) is about 1 mm. The thickness of the holding part 16 corresponding thereto is about 2 mm.

After the synthetic resin socket 1 and the heat sink 3 are screwed tied, the bottom side (surface one) of the synthetic resin socket 1 is flat and can be closely contact to the heat sink 3.

With such constitution, by temporarily setting the LED module 2 and screwing tie to the heat sink 3 with the synthetic resin socket 1, the simple installation can be achieved. Nevertheless, the LED module 2 will not fall and is fixed between the synthetic resin socket 1 and the heat sink 3. There will be no detachment occurring due to the failing installation.

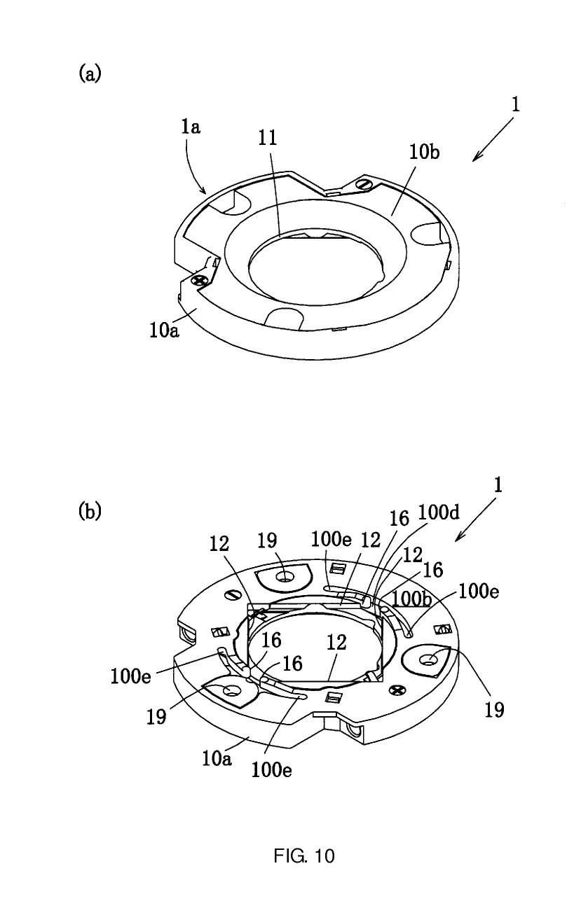

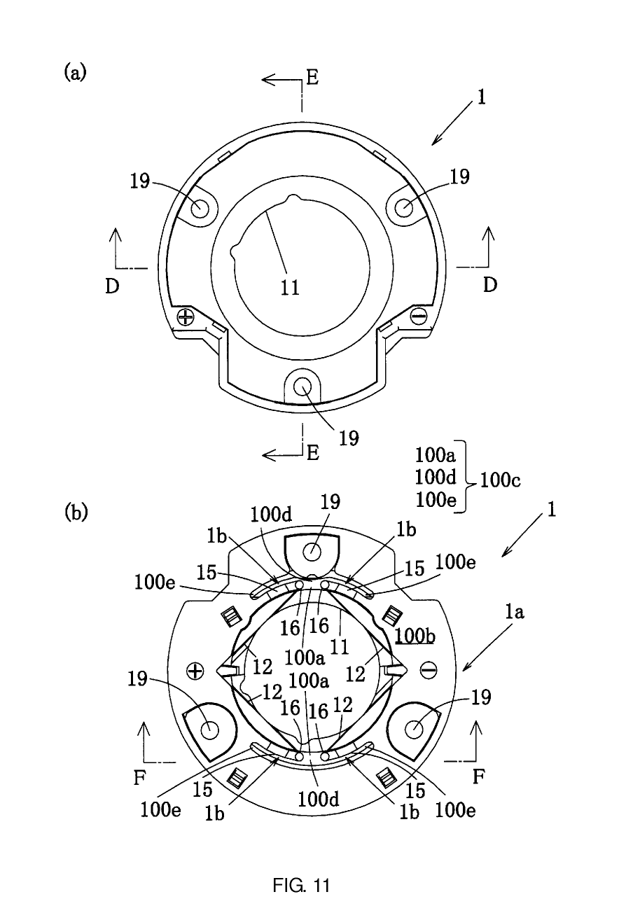

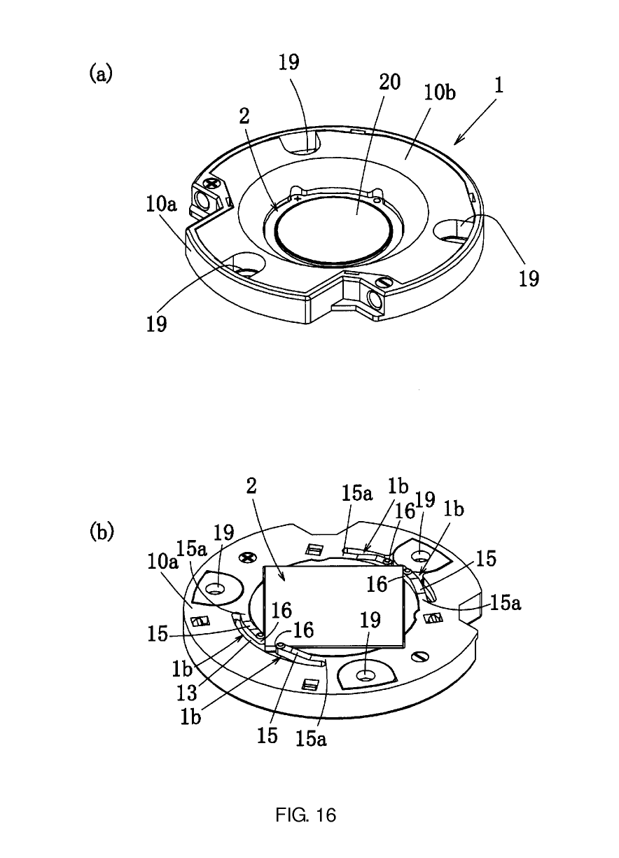

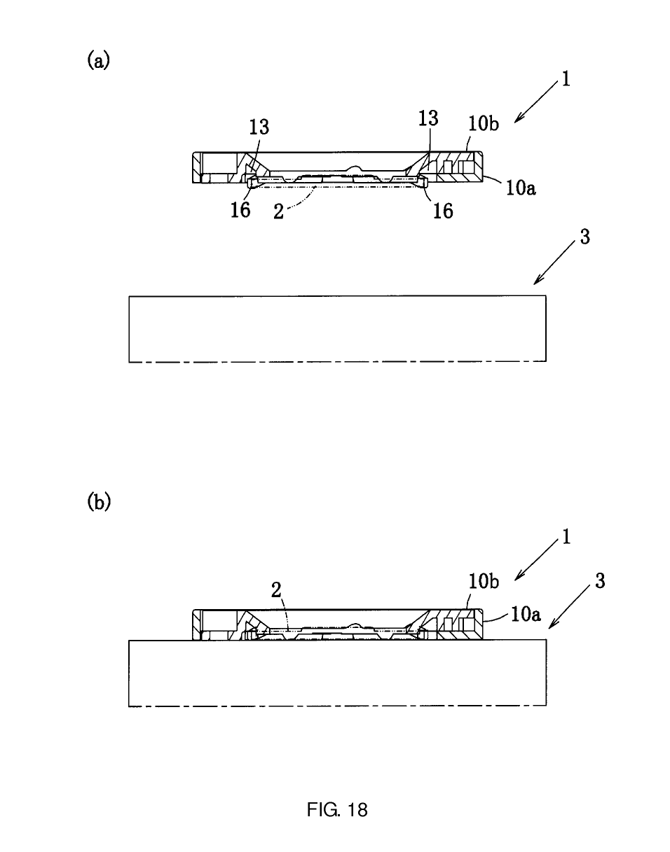

Then, the synthetic resin socket 1 according to the second embodiment of the present invention is introduced here. Please refer FIG. 10 to FIG. 18 for further descriptions. Besides, the same number as those of the first embodiment will be employed as the common constitution of the synthetic resin socket 1 according to the first embodiment is applied.

The synthetic resin socket 1 according to the second embodiment of the present invention is rough circular synthetic resin socket as shown from FIG. 10 to FIG. 18. Although the appearance and the shape are quite different from the first embodiment, the basic constitution of the invention can be substantially common.

The synthetic resin socket 1 of the second embodiment according to the present invention is constituted by a socket frame plate 10a made of synthetic resin and a socket substrate 10b made of synthetic resin. The socket main body 1a, which respectively accommodates terminal metal parts 5, 5 at the positive and negative sides, comprises a guide recess 12 for determining the position of the LED module 2 and a holder 1b for holding the LED module 2.

Meanwhile, a light opening 11 is formed at the center of the synthetic resin socket 1. The guide recess 12 of determining the position of the LED module 2 and a holder 1b for holding the LED module 2 hold the bottom side of the LED module 2. The LED power unit 21 of the LED module 2 and the terminal metal parts 5, 5 are in contact status and as similar as the first embodiment, the LED light source 20 of the LED module 2 projects light through the light opening 11 of the synthetic resin socket 1.

Moreover, in the synthetic resin socket 1 of the second embodiment, the appearance and the amount of the arms 15, the status of holding the LED module 2 of the arms 15 are different from the first embodiment. An arm forming cutout 100c is formed at the frame 100b of the socket frame plate 10a, which constitutes the bottom of the synthetic resin socket 1. Arms 15 and holding parts 16 are provided to constitute the holder 1b.

Specifically, with a first arm forming cutout 100d radically extending outward from a part of a frame side opening 100a and a second arm forming cutout 100e extending from the front end of the first arm forming cutout 100d to the left and right sides along the frame side opening 100a, the arms 15 are formed, and the arms 15 are adjacent to the frame side opening 100a, the first arm forming cutout 100d and the second arm forming cutout 100e. Meanwhile, the holding parts 16 extending from the front end of the arms 15 are formed.

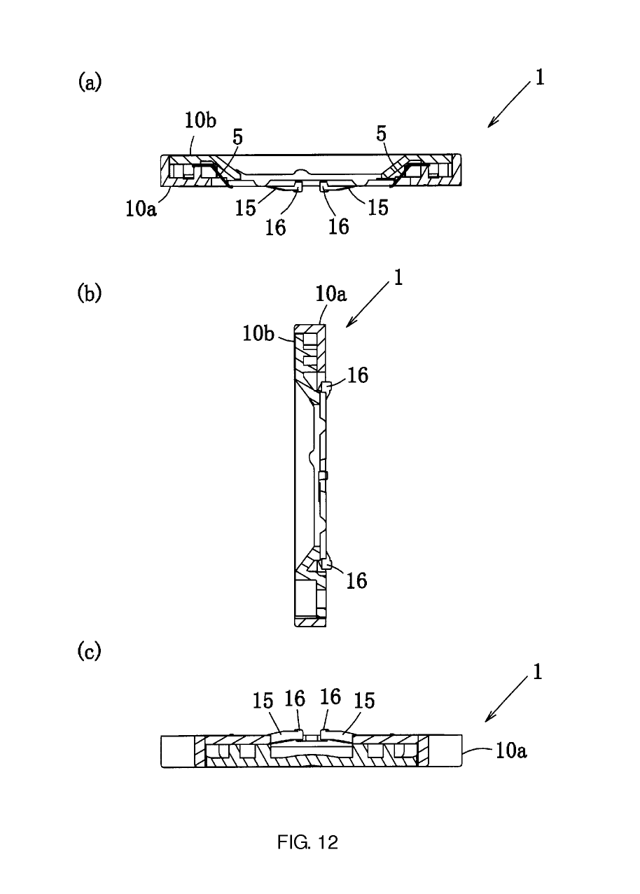

Accordingly, by forming the second arm forming cutout 100e toward the left and right sides, two arms 15 are formed herewith. Moreover, the locations of the two arms 15 are not in the same horizontal plane of the frame 100b. As shown in FIG. 12, the arms 15 protrude from the bottom side of the frame 100b downwards roughly starting from the center position of the arms 15 themselves.

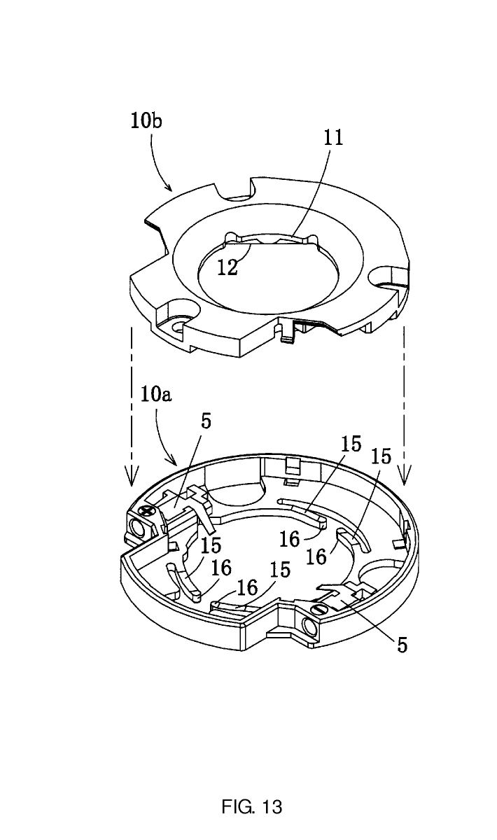

As constituting the synthetic resin socket 1 with the socket frame plate 10a and the socket substrate 10b, accommodating rooms 13 for accommodating the arms 15 inside the synthetic resin socket 1 are formed. Meanwhile, the terminal metal part 5 is installed to the socket frame plate 10a and as shown in FIG. 13, the socket frame plate 10a and the socket substrate 10b are assembled.

The arms 15 formed by the two second arm forming cutout 100e extending from the first arm forming cutout 100d are components functioned to hold the LED module 2.

In the second embodiment, the two arms 15 of one set as aforementioned are located at positions of the front side direction and the back side direction inside the frame side opening 100a.

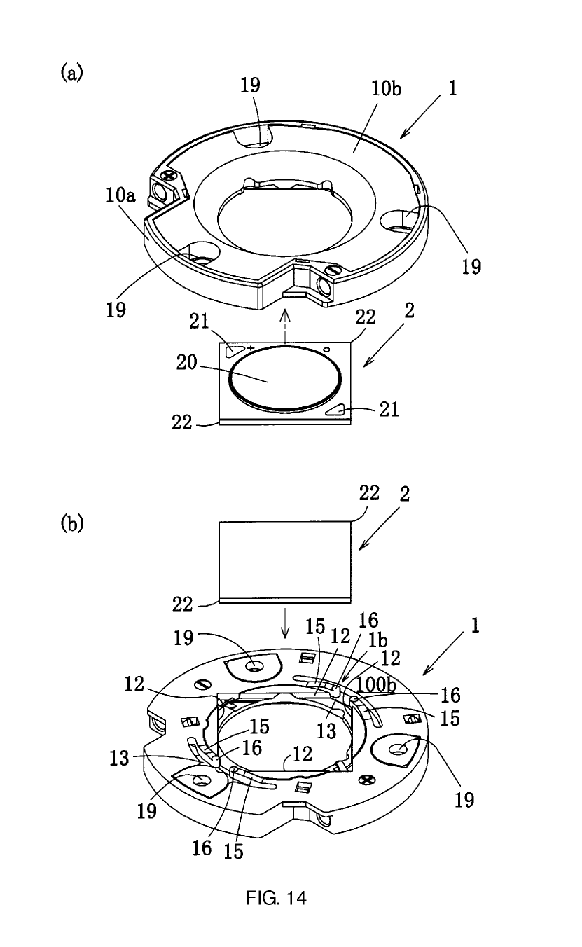

By employing the synthetic resin socket 1 of the second embodiment, the installation of the LED module 2 to the heat sink 3 is introduced by referring to FIG. 14 to FIG. 18. The LED module 2 which is rectangular in top view is guided against the guide recess 12 from the back side of the synthetic resin socket 1.

As similarly described in the first embodiment, the front ends of the terminal metal part 5, 5 protrude near the guide recess 12 and contact the LED power unit 21 of the LED module 2.

In the second embodiment, two opposite corners 22 of the LED module 2 are held and temporarily set by the respective front ends of two arms of two sets.

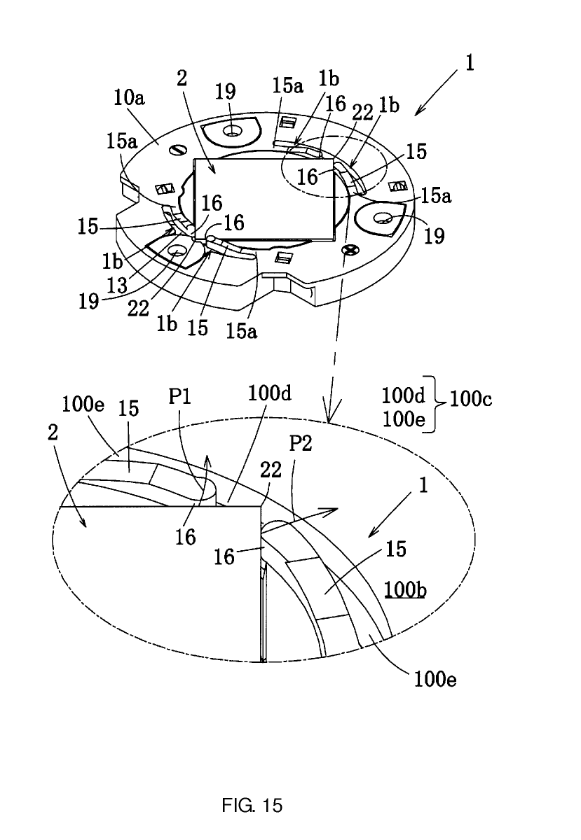

The two arms 15 of one set protruding from the bottom side of the synthetic resin socket 1 downwards respectively presses against two adjacent side of the LED module 2. As indicated by the arrows P1, P2 shown in FIG. 15, the arms 15 are only deformed outwards. With the reaction, the LED module 2 is temporarily set by the respective front ends of the arms 15 of two sets. In this embodiment, the two holding parts 16 are the respective front ends of the two arms 15 of one set.

The temporarily set status of the LED module 2 is maintained by the arms 15 respectively protruding from the bottom side of the synthetic resin socket 1 downwards. Besides, the LED module 2 are held by the parts of the respective lateral sides of the LED module 2 are shallowly embedded in the guide recess 12 of the synthetic resin socket 1.

In such constitution, the temporarily setting can be achieved with fingers by lightly pushing the two opposite corners of the LED module 2 aligned between the arms 15.

Next, installation of the synthetic resin socket 1 of the second embodiment to the heat sink 3 in which the LED module 2 is temporarily set is proceeded.

In the second embodiment, as similarly described in the first embodiment, by screwing the screwing means (male screw), such as screwing with the female screw of the heat sink 3, the holding parts 16 protruding from the bottom side of the synthetic resin socket 1 are slightly moved inwards toward the inside of the holder accommodating room 13. However, because the thickness of the holding parts 16 is slightly larger than that of the LED module 2, the LED module 2 will not deviate from the holding parts 16. Only the holding parts 16 enters the inside of the holder accommodating room 13 and the LED module 2 presses against the guide recess 12 due to the static friction between the LED module 2 and the holding parts 16. After the synthetic resin socket 1 and the heat sink 3 are screwed tied, the bottom side (surface one) of the synthetic resin socket 1 is flat and can be closely contact to the heat sink 3.

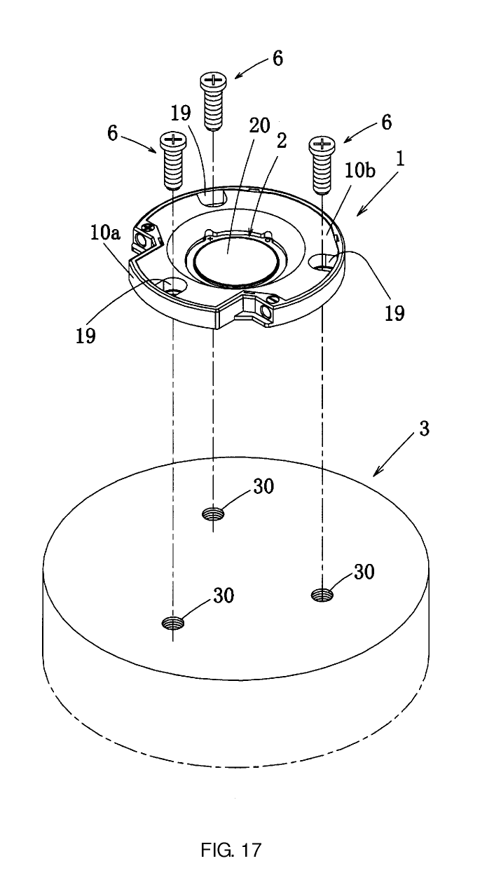

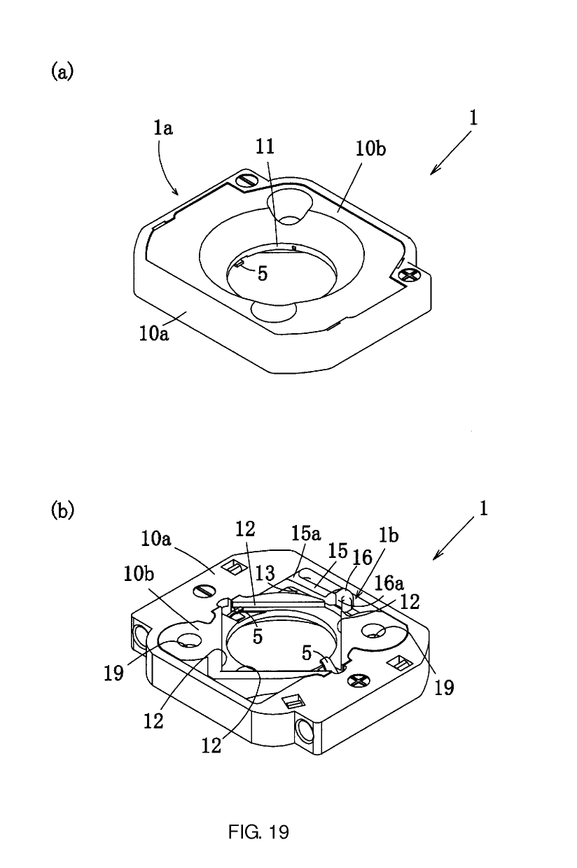

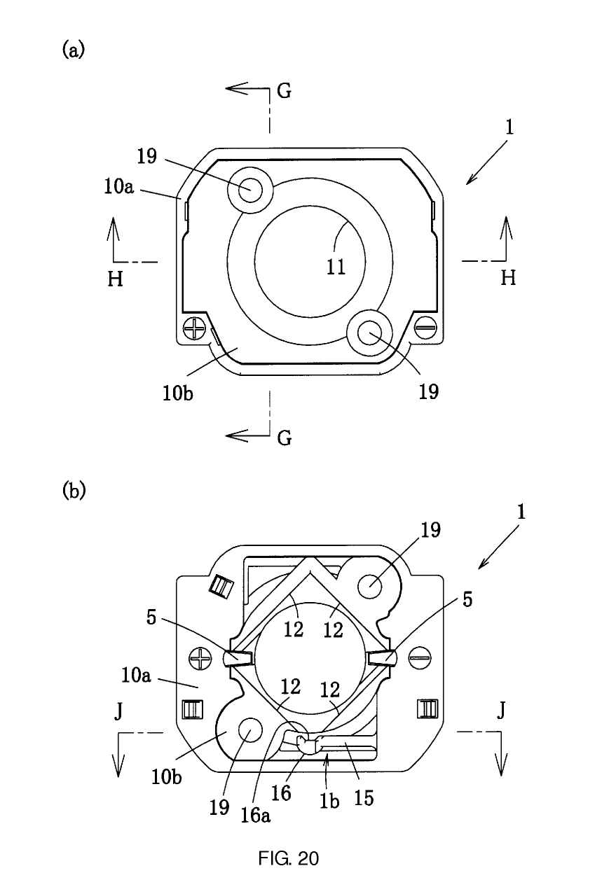

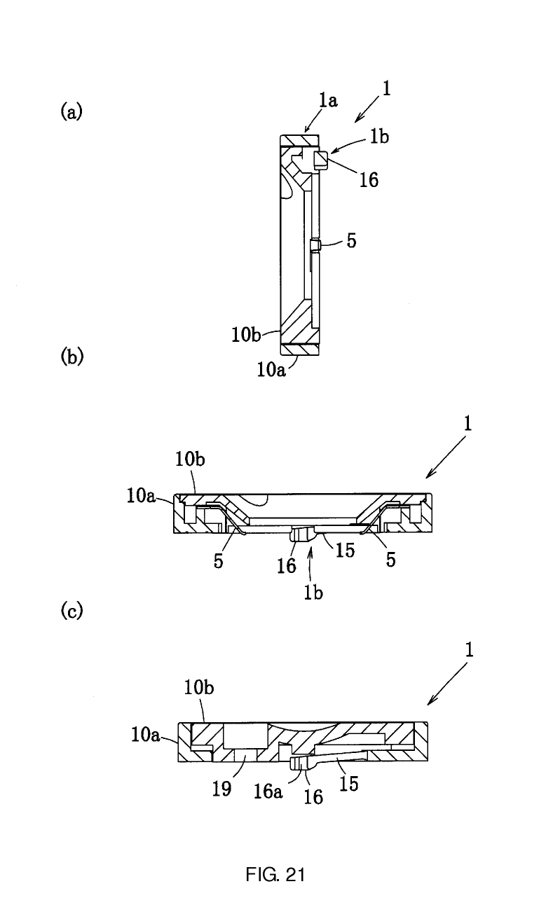

Then, the synthetic resin socket 1 according to the third embodiment of the present invention is introduced here. Please refer FIG. 19 to FIG. 17 for further descriptions. Besides, the same numbers will be employed in the third embodiment as the common constitution of the synthetic resin socket 1 according to the first, second embodiments is applied.

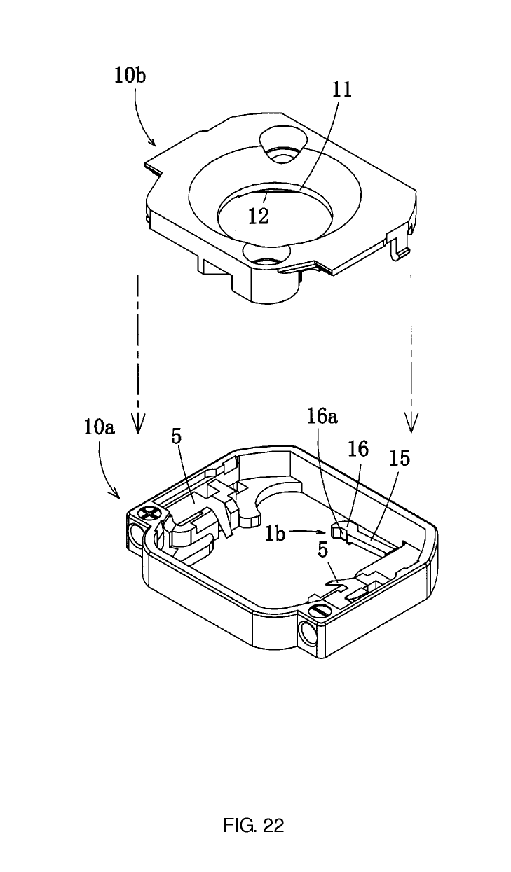

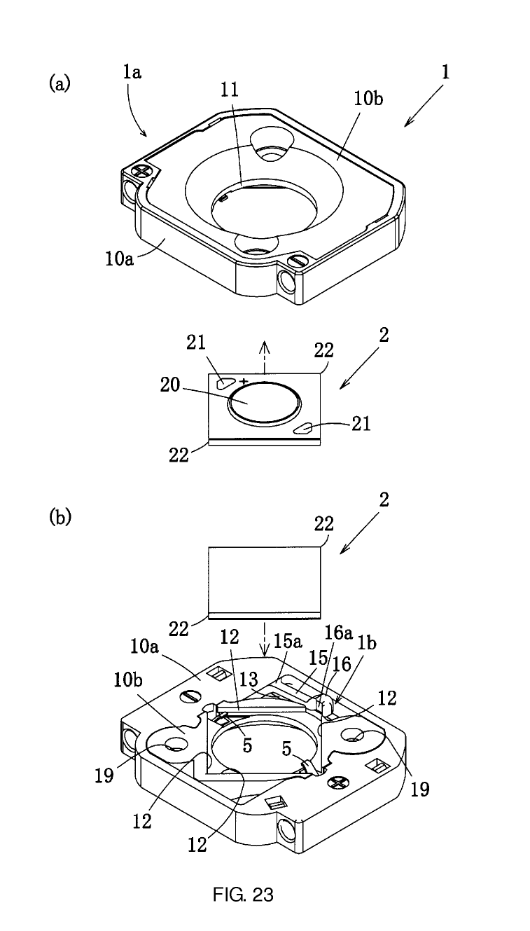

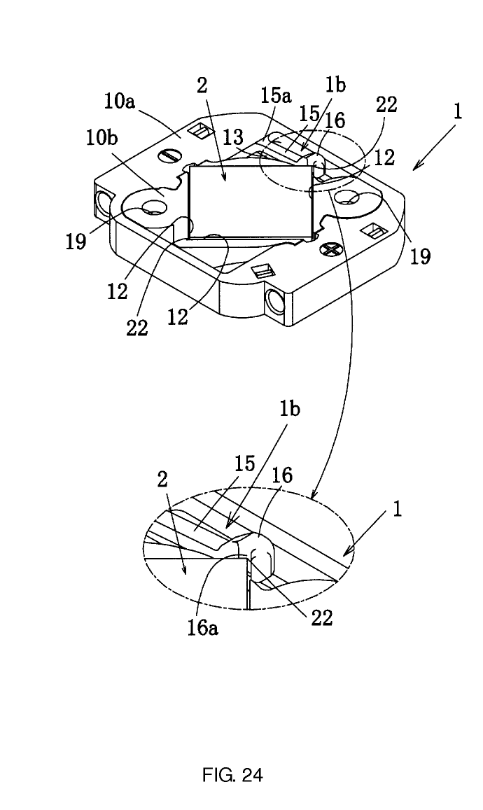

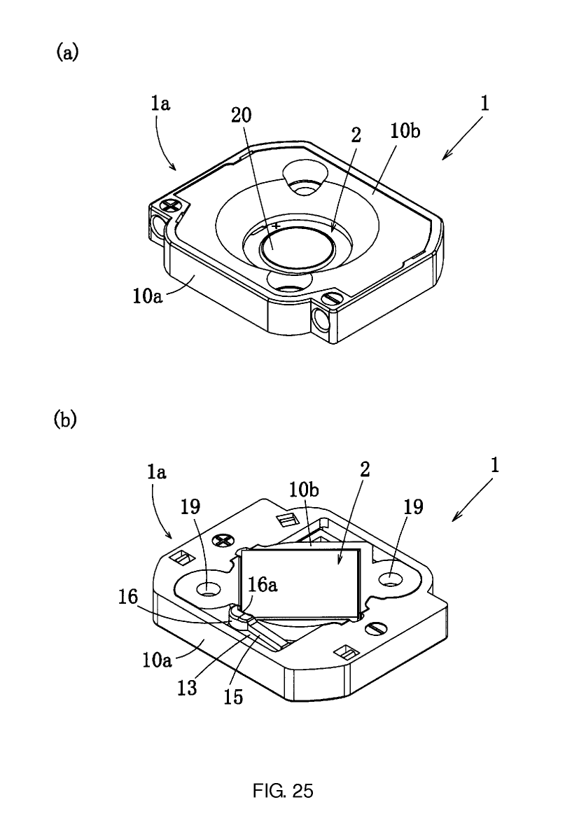

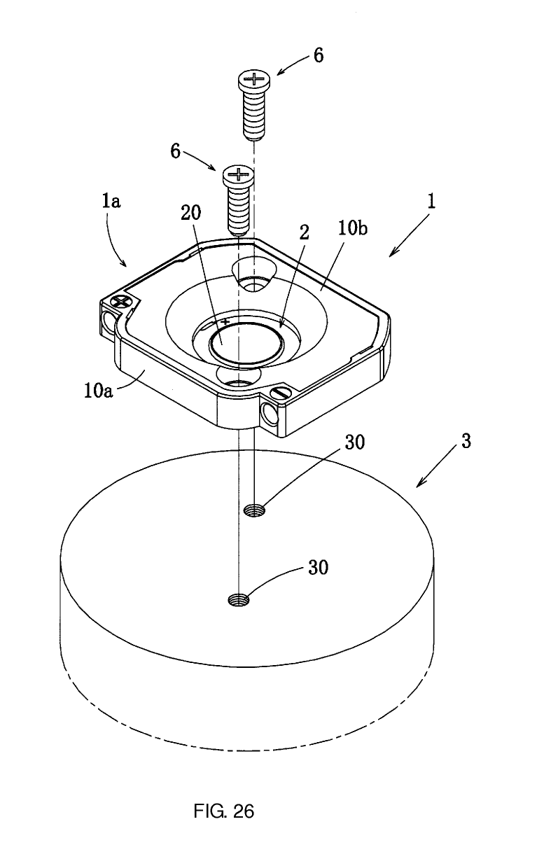

The synthetic resin socket 1 of the third embodiment according to the present invention is constituted by a socket frame plate 10a and a socket substrate 10b made of synthetic resin. The socket main body 1a, which respectively accommodates terminal metal parts 5, 5 at the positive and negative sides, comprises a guide recess 12 for determining the position of the LED module 2 and a holder 1b for holding the LED module 2. A light opening 11 is formed at the center of the synthetic resin socket 1. The guide recess 12 of determining the position of the LED module 2 and a holder 1b for holding the LED module 2 hold the bottom side of the LED module 2. The LED power unit 21 of the LED module 2 and the terminal metal parts 5, 5 are in contact status and as similar as the first, second embodiments, the LED light source 20 of the LED module 2 projects light through the light opening 11 of the synthetic resin socket 1. Meanwhile, as the assembled synthetic resin socket 1 shown in FIG. 22 and FIG. 23, the installation to the heat sink 3 shown in FIG. 26 can be performed roughly the same as the procedures of the first, second embodiments.

Besides, although the appearance of the synthetic resin socket 1 of the third embodiment is quite similar as that of the first embodiment, the difference therefrom is that only one holder 1b (the arm 15 and holding part 16) is provided herewith. Besides, the holding part 16 comprises cutouts 16a as the same as the first embodiment.

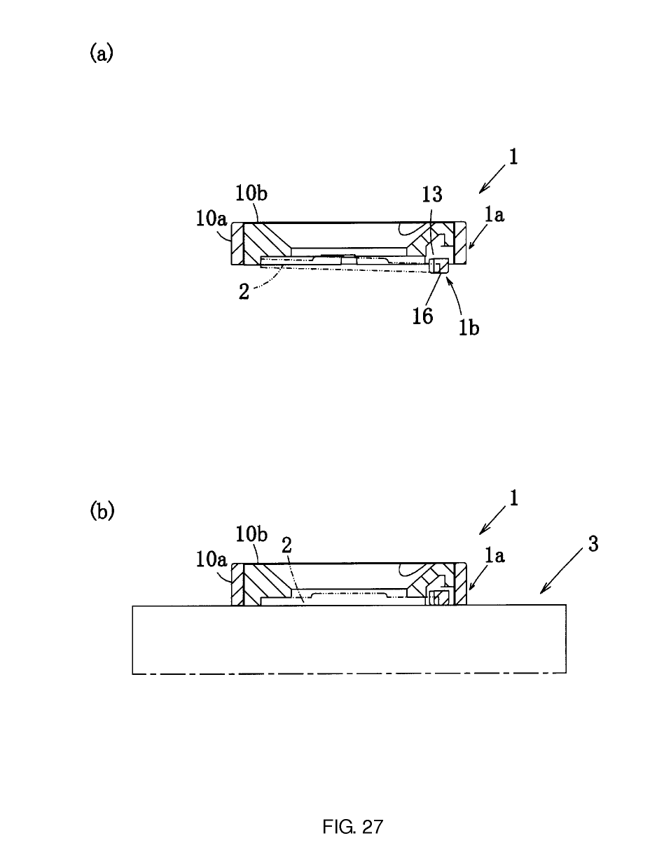

The holding part 16 of the holder 1b according to the third embodiment protrudes downwards from the bottom side and closely contacts with a corner 22 of the LED module 2. When the LED module 2 is pressed against by the corner 22 in the diagonal direction, the guide recess 12 at the diagonal location and the holder 1b are employed for holding the LED module 2. With such constitution, as shown in FIG. 27, the LED module 2 is held by the holding part 16 protruding downwards from the bottom side of the synthetic resin socket 1 and the guide recess 12 formed at the bottom side. The LED module 2 is not parallel with the bottom side of the synthetic resin socket 1 but is set in a status of slight tilting.

During the mounting, one corner 22 of the LED module 2 is first to closely contacting the guide recess 12. Then, the holder 1b is deformed and the opposite corner (the other corner 22) is embedded into the cutouts 16a of the holder 1b and the simple mounting is completed. In such constitution, the guide recess 12 contacted by the one corner 22 is not deformed. Therefore, the mounting of the LED module 2 becomes easier.

Furthermore, after the other corner 22 is embedded into the cutouts 16a of the holder 1b, the one corner 22 of the LED module 2 can be inserted into the opposite guide recess 12 for mounting. In such scenario, the guide recess 12 will not be deformed as the one corner 22 of the LED module 2 is inserted into the guide recess 12. Therefore, the location of the LED module 2 can be quickly determined and mounting the LED module 2 becomes easier.

Meanwhile, the installation to the heat sink 3 is proceeded under the circumstance that the LED module 2 is held and temporarily set in the synthetic resin socket 1. With the holder 1b, attaching the LED module 2 with the heat sink 3 and accommodating the holder 1b inside the holder accommodating room 13, the LED module 2 is ultimately fixed in a roughly horizontal status.

Besides, in the first embodiment, a pair of the holder 1b is point symmetrically positioned which a rough center position of a receiving space holding the LED module 2 is a reference point. The reaction due to the elastic deformation of the holder which can hold the LED module 2 from the two lateral sides toward the rough center of the LED module 2 with great balance can be provided. Then, the loading to the LED module 2 can be reduced. However, this is not a limitation to the present invention. Although not shown in figures, the holders 1b can be not point symmetrically positioned. Moreover, the pair of the holder 1b can be not parallel. The distance between the front ends can be smaller than that between the base 15a optionally. Furthermore, two pairs of holders 1b can be provided.

Besides, in the first embodiment, the fitting recesses 101a of the socket frame plate 10a and the fitting protrusions 101b of the socket substrate 10b are embedded for realizing the fixation. However, this is not a limitation to the present invention, either. Although not shown in figures, other mutual engagement means and other well known means can be illustrated for examples.

Besides, the appearance of the heat sink as being the object to be installed is not limited. The fixing screws 5 and the tapped holes 30 corresponding thereto disclosed in first to third embodiments can be provided. Moreover, regardless of whether the heat sink and the socket are detachable or not, mutually detachable metal parts, kinds of well known meal-female joint means are all can be provided therewith.

Besides, in the present invention, at least one pair of holders can be provided to hold the LED module 2. For example, the constitutions such as that one single holder and guide recess 12 hold the LED module 2 in the third embodiment or that four holders of two sets hold one pair of corner 22 of the LED module 2 and the guide recess 12 holds another pair of corner 22 in the second embodiment can be illustrated for possibilities.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A synthetic resin socket, having a holder in a socket main body made of synthetic resin for holding the LED module,
the holder comprises an arm and a holding part formed at a front end of the arm;
at least one holder accommodating room is formed at a bottom side of the socket main body;
the holder protrudes from the inside of the holder accommodating room toward the lower surface of the socket main body for holding and temporarily setting the LED module; and
the arm of the holder is possible to be laterally elastically deformed, and as installation to an object to be installed, the object to be installed presses against the holder and the arm provides resin elasticity to secure the hold status of the LED module, and the holder is elastically deformed toward the inside of the holder accommodating room to be accommodated.

2. The synthetic resin socket according to claim 1, wherein the arm of the holder is rectangular in cross section.

3. The synthetic resin socket according to claim 2, wherein a guide recess in accordance with an appearance of the LED module is formed at the bottom side of the socket main body.

3. The synthetic resin socket according to claim 3, wherein the LED module is held by the guide recess and the holder.

4. The synthetic resin socket according to claim 4, wherein a pair of the arm is point symmetrically positioned and a rough center position of a receiving space holding the LED module is a reference point of the pair of the arm.

5. The synthetic resin socket according to claim 1, wherein a guide recess in accordance with an appearance of the LED module is formed at the bottom side of the socket main body.

6. The synthetic resin socket according to claim 6, wherein the LED module is held by the guide recess and the holder.

7. The synthetic resin socket according to claim 7, wherein a pair of the arm is point symmetrically positioned and a rough center position of a receiving space holding the LED module is a reference point of the pair of the arm.

8. The synthetic resin socket according to claim 1, wherein a pair of the arm is point symmetrically positioned and a rough center position of a receiving space holding the LED module is a reference point of the pair of the arm.

9. The synthetic resin socket according to claim 2, wherein a pair of the arm is point symmetrically positioned and a rough center position of a receiving space holding the LED module is a reference point of the pair of the arm.

10. A synthetic resin socket, having a holder in a socket main body made of synthetic resin for holding the LED module,
the holder comprises an arm and a holding part formed at a front end of the arm;
at least one holder accommodating room is formed at a bottom side of the socket main body;
at least a pair of the holder protrudes from the inside of the holder accommodating room toward the lower surface of the socket main body for holding and temporarily setting the LED module; and
the arm of the holder is possible to be laterally elastically deformed, and as installation to an object to be installed, the object to be installed presses against the holder and the arm provides resin elasticity to secure the hold status of the LED module, and the holder is elastically deformed toward the inside of the holder accommodating room to be accommodated.

11. The synthetic resin socket according to claim 11, wherein the arm of the holder is rectangular in cross section.

12. The synthetic resin socket according to claim 12, wherein a guide recess in accordance with an appearance of the LED module is formed at the bottom side of the socket main body.

13. The synthetic resin socket according to claim 13, wherein the LED module is held by the guide recess and the holder.

14. The synthetic resin socket according to claim 14, wherein a pair of the arm is point symmetrically positioned and a rough center position of a receiving space holding the LED module is a reference point of the pair of the arm.

15. The synthetic resin socket according to claim 11, wherein a guide recess in accordance with an appearance of the LED module is formed at the bottom side of the socket main body.

16. The synthetic resin socket according to claim 16, wherein the LED module is held by the guide recess and the holder.

17. The synthetic resin socket according to claim 17, wherein a pair of the arm is point symmetrically positioned and a rough center position of a receiving space holding the LED module is a reference point of the pair of the arm.

18. The synthetic resin socket according to claim 11, wherein a pair of the arm is point symmetrically positioned and a rough center position of a receiving space holding the LED module is a reference point of the pair of the arm.

19. The synthetic resin socket according to claim 12, wherein a pair of the arm is point symmetrically positioned and a rough center position of a receiving space holding the LED module is a reference point of the pair of the arm.
